(19) United States
(12) Patent Application Publication
(10) Pub. No.: US 2015/0325824 A1
(43) Pub. Date: Nov. 12, 2015

(54) BATTERY BLOCK, BATTERY MODULE, AND BATTERY BLOCK HOLDER

(71) Applicant: SANYO ELECTRIC CO., LTD., Daito-shi, Osaka (JP)

(72) Inventors: TAKASHI HASEGAWA, Osaka (JP); AKIRA TAKANO, Osaka (JP)

(21) Appl. No.: 14/762,806

(22) PCT Filed: Jan. 28, 2014
(86) PCT No.: PCT/JP2014/000417

§ 371 Date: Jul. 22, 2015

(30) Foreign Application Priority Data
Jan. 29, 2013 (JP) 2013-014064

(51) Int. Cl. H01M 2/10; H01M 10/0525; H01M 2/12; H01M 2/20

(52) U.S. Cl. CPC H01M 2/1016; H01M 2/105; H01M 2/1072; H01M 2/202; H01M 2/204; H01M 2/206; H01M 10/0525; H01M 2/12

(57) ABSTRACT

Battery block includes: a plurality of cells having a cylindrical outer shape; a case that is used for arranging cells in a predetermined arrangement by aligning the positive electrodes of cells on one side and aligning the negative electrodes thereof on the other side, is open on the one side and the other side, and holds cells along the outer periphery in the longitudinal direction of cells; positive-side collection portion that is disposed in the opening on the one side of case and interconnects the positive electrodes of cells to collect power; negative-side collection portion that is disposed in the opening on the other side of case and interconnects the negative electrodes of cells to collect power; and two holders that are disposed so as to fit to opposite surfaces of the outer shape of case, respectively, and are made of an insulator.

### TECHNICAL FIELD

The present invention relates to a battery block formed by interconnecting a plurality of cells, a battery module formed by interconnecting a plurality of battery blocks, and a holder used for a battery block.

### BACKGROUND ART

In order to obtain a desired voltage and current, a battery block formed by interconnecting, combining, and integrating a plurality of cells is used, and a battery module formed by interconnecting a plurality of battery blocks is used.

For example, Patent Literature 1 discloses a battery box corresponding to a battery block. The battery box includes a cover plate and base plate that are disposed on the upside and downside of a plurality of cylindrical cells stored in a laid state, a plurality of bolts connecting the cover plate to the base plate, and a grasp bar whose both ends are inserted into the bolts and connected to each other, and that vertically grasps the cells and arranges them at fixed positions.

### CITATION LIST

### Patent Literature

PTL 1: Unexamined Japanese Patent Publication No. 2007-234369

### SUMMARY OF THE INVENTION

The purpose of the present invention is to combine and integrate a plurality of cells at a high accuracy and high workability in a battery block and battery module.

The battery block of the present invention includes the following components:

a plurality of cells;

a case that is used for arranging the plurality of cells in a predetermined arrangement by aligning the positive electrodes of the cells on one side and aligning the negative electrodes thereof on the other side, is open on the one side and the other side, and holds the cells along the outer periphery in the longitudinal direction of the cells;

a positive-side collection portion that is disposed in the opening on the one side of the case and interconnects the positive electrodes of the cells in parallel to collect power;

a negative-side collection portion that is disposed in the opening on the other side of the case and interconnects the negative electrodes of the cells in parallel to collect power;

two holders that are disposed so as to fit to opposite surfaces of the outer shape of the case, respectively, and are made of an insulator; and

a fastening member for fastening the positive-side collection portion and negative-side collection portion via the two holders.

The battery module of the present invention is a battery module formed by interconnecting in series a plurality of battery blocks each of which includes a plurality of cells interconnected in parallel. Each battery block includes the following components:

a plurality of cells;

a case that is used for arranging the plurality of cells in a predetermined arrangement by aligning the positive electrodes of the cells on one side and aligning the negative electrodes thereof on the other side, is open on the one side and the other side, and holds the arranged cells along the outer periphery in the longitudinal direction of the cells;

a positive-side collection portion that is disposed in the opening on the one side of the case and interconnects the positive electrodes of the cells in parallel to collect power;

a negative-side collection portion that is disposed in the opening on the other side of the case and interconnects the negative electrodes of the cells in parallel to collect power;

two holders that are disposed so as to fit to opposite surfaces of the outer shape of the case, respectively, and are made of an insulator; and

a fastening member for fastening the positive-side collection portion and negative-side collection portion via the two holders.

The holder for a battery block of the present invention includes two holders. The two holders are fitted to fitting portions disposed on opposite surfaces of the outer shape of the case for aligning and holding a plurality of cells in the longitudinal direction. The holders are disposed between a positive-side collection portion of the cells that is disposed on one side of the case and a negative-side collection portion of the cells that is disposed on the other side of the case. The holders are made of an insulator. The holders are fastened to the positive-side collection portion on the one side, are fastened to the negative-side collection portion on the other side, and integrate the case, the positive-side collection portion, the negative-side collection portion to form a battery block.

### BRIEF DESCRIPTION OF DRAWINGS

FIG. 1 is a perspective view showing a battery block in an example of an exemplary embodiment of the present invention.

FIG. 2 is an exploded view of the battery block of FIG. 1.

FIG. 3 is a top view, front view, and bottom view of the battery block of FIG. 1.

FIG. 4 is a perspective view showing a battery module in the example of the exemplary embodiment of the present invention.

FIG. 5 is a top view, front view, and bottom view of the battery module of FIG. 4.

FIG. 6 is a front view and side view when a duct chamber is disposed in the battery module in the example of the exemplary embodiment of the present invention.

FIG. 7 is a sectional view showing the relationship between a safety valve and the duct chamber in FIG. 6.

FIG. 8 is a sectional view showing a connection method between adjacent battery blocks in the battery module of FIG. 6.

FIG. 9 is a sectional view showing a connection method different from the connection method of FIG. 8.

FIG. 10 is a perspective view showing a battery module of a modified example of the present invention.

FIG. 11 is a perspective view showing an exploded view of the battery module of the modified example of the present invention.

### DESCRIPTION OF EMBODIMENTS

An exemplary embodiment of the present invention is described hereinafter in detail with reference to the accompanying drawings. In this description, the material, the dimension, the shape, the number of cells, and the number of battery modules are examples for description, and can be appropriately modified in accordance with the specification of the battery block and battery module. Hereinafter, corresponding components in all drawings are denoted with the same reference marks, and the duplication of the descriptions is omitted.

### Exemplary Embodiment

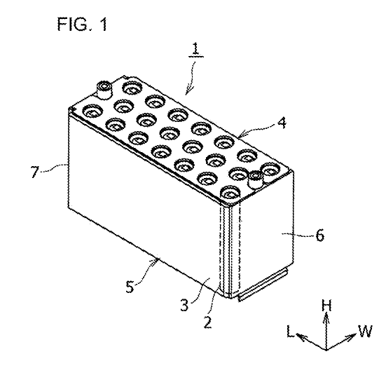

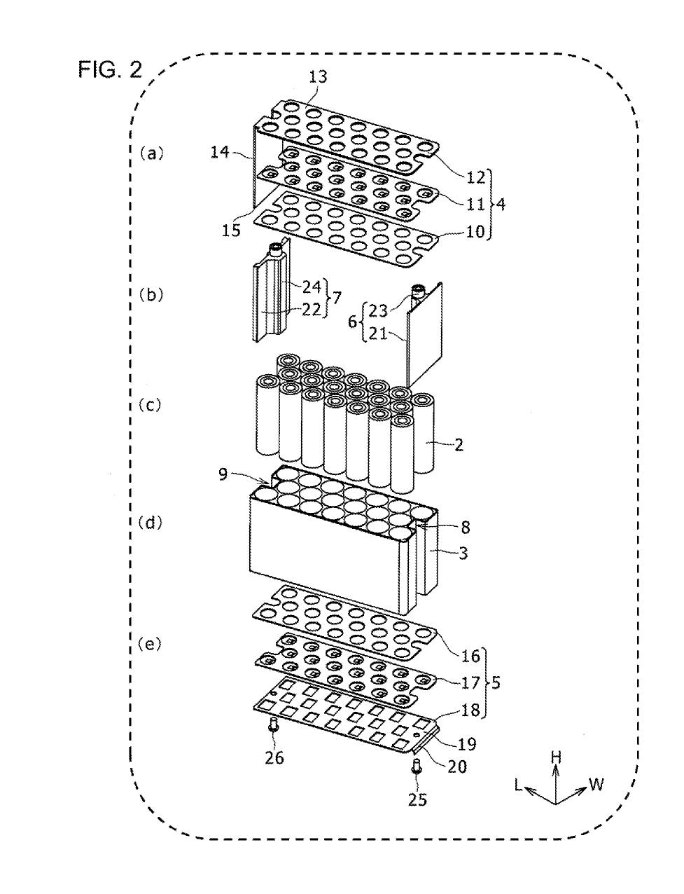

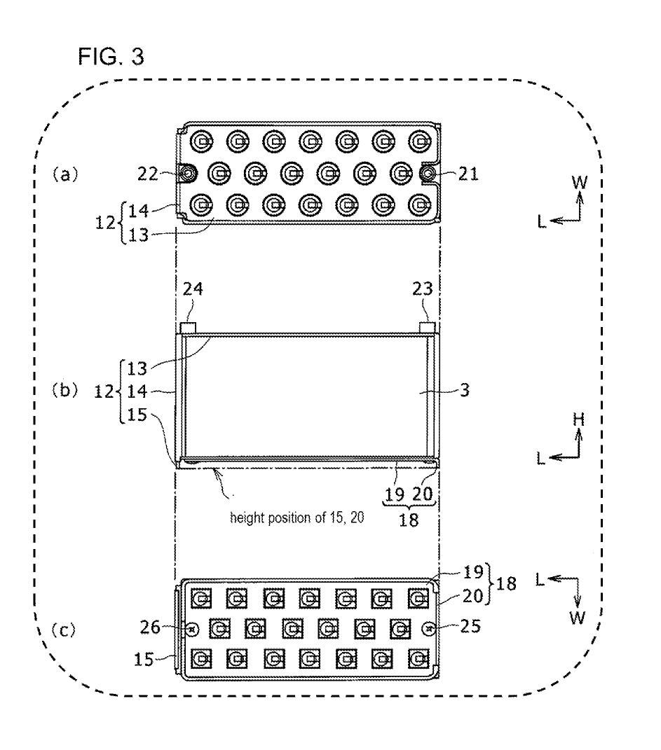

FIG. 1 is a perspective view showing battery block 1. FIG. 2 is an exploded view of battery block 1. FIG. 3 is a trihedral diagram of battery block 1. FIG. 3 (a) is a top view, FIG. 3 (b) is a front view, and FIG. 3 (c) is a bottom view. In battery block 1, a predetermined capacity is obtained by interconnecting a plurality of cells 2 in parallel. In this configuration, 20 cells 2 are used. Battery block 1 is obtained by the following processes of:

arranging 20 cells 2 in a predetermined arrangement by aligning the positive electrodes of cells 2 on one side and aligning the negative electrodes thereof on the other side;

holding cells 2 in case 3;

disposing positive-side collection portion 4 on the positive side;

disposing negative-side collection portion 5 on the negative side; and

fastening positive-side collection portion 4 and negative-side collection portion 5 via holders 6 and 7 using appropriate fastening members 25 and 26.

In FIG. 1, the H direction, L direction, and W direction are shown as three mutually orthogonal axes. The H direction shows the longitudinal direction of cells 2. The L direction and W direction show arrangement directions of two-dimensional arrangement of cells 2. The direction along the longer side is set as the L direction, and the direction along the shorter side is set as the W direction. The same is true of the following diagrams.

Each cell 2 is a chargeable/dischargeable secondary cell. As the secondary cell, a lithium-ion cell is used. Furthermore, a nickel-metal-hydride cell or an alkaline cell may be used. FIG. 2 (c) shows a perspective view of 20 cells 2 in the state where they are stored and arranged in battery block 1. As shown here, 20 cells 2 are arranged in a staggered (zigzag) format that minimizes the clearances between adjacent cells. Three rows of cells are arranged in the W direction, and seven cells, six cells, and seven cells are arranged along the L direction in respective rows.

Each cell 2 has a cylindrical outer shape. One of both ends of the cylindrical shape is used as a positive terminal, and the other is used as a negative terminal. An example of each cell 2 is a lithium-ion cell in which the diameter is 18 mm, the height is 65 mm, the voltage between the terminals is 3.6 V, and the capacity is 2.5 Ah. These values are examples for description, and other dimensions and characteristic values may be used. Each cell 2 is not limited to a cylindrical cell, and may be a cell having another outer shape.

Case 3 is a holding vessel for holding 20 cells 2 in a state where they are aligned and arranged in a predetermined arrangement. FIG. 2 (d) shows a perspective view of case 3. Case 3 is a frame body that has the same height as that of cells 2 and includes 20 cell storage portions. Both ends of each cell storage portion in the height direction are open. Each cell 2 is stored and disposed in each cell storage portion.

The cell storage portions are arranged in a staggered format in association with the arrangement of cells 2 shown in FIG. 2 (c). In other words, three rows of cell storage portions are arranged in the W direction and seven cell storage portions, six cell storage portions, and seven cell storage portions are arranged along the L direction in respective cell storage portion rows. Therefore, the length of the middle cell-storage-portion row along the L direction is shorter than those of cell-storage-portion rows on both sides along the L direction. Thus, grooves 8 and 9 as margin spaces having no cell 2 are formed in middle parts along the W direction at both ends of case 3 along the L direction. Grooves 8 and 9 extend from the one side to the other side of cells 2 along the H direction as the longitudinal direction of cells 2, and are recessed toward the part where cells 2 are arranged.

As case 3, a case that is made of aluminum and has a predetermined shape formed by extrusion molding can be employed.

When 20 cells 2 are stored and arranged in the cell storage portions in case 3, the positive electrodes of cells 2 are aligned on one side, and the negative electrodes thereof are aligned on the other side. In FIG. 1, the one side corresponds to the upside of the page along the H direction, and the other side corresponds to the downside of the page along the H direction.

Positive-side collection portion 4 is a connection member that is disposed so as to block the opening on the one side of case 3 and electrically interconnects the positive electrodes of aligned cells 2. FIG. 2 (a) shows positive-side collection portion 4. As shown here, positive-side collection portion 4 includes positive-side insulating plate 10, positive electrode collector 11, and positive electrode plate 12. Each of positive-side insulating plate 10, positive electrode collector 11, and positive electrode plate 12 includes cut-away portions corresponding to grooves 8 and 9 described for case 3.

Positive-side insulating plate 10 is a plate material that is disposed between case 3, and positive electrode collector 11 and positive electrode plate 12 and electrically insulates case 3 from them. Positive-side insulating plate 10 includes 20 openings through which the positive electrodes of cells 2 are projected. Positive-side insulating plate 10 is formed by processing, in a predetermined shape, a plastic molded article or plastic sheet having a predetermined heat resistance and electrical insulating property.

Positive electrode collector 11 is a thin plate including 20 electrode contact portions. The electrode contact portions are arranged in a positional relation in which each electrode contact portion elastically comes into contact with the positive electrode of each cell 2. In positive electrode collector 11, the electrode contact portions having a predetermined shape may be formed by etching or pressing a metal thin plate having electric conductivity.

Positive electrode plate 12 is an electrode plate that is electrically connected to positive electrode collector 11 and is used for forming one positive-side output terminal by interconnecting 20 electrode contact portions. Positive electrode plate 12 is a folded plate, and includes plane portion 13 facing positive electrode collector 11, and side surface portion 14 that is folded from an end in the L direction of plane portion 13 toward negative-side collection portion 5 along the H direction. The folding of positive electrode plate 12 from plane portion 13 to side surface portion 14 is performed at the end in the L direction and on the holder 7 side, namely on the left side on the page of FIG. 2. Plane portion 13 includes 20 openings so that each electrode contact portion of positive electrode collector 11 can be deformed elastically. The length of side surface portion 14 along the H direction is set so that the position of tip 15 along the H direction corresponds to the arrangement position of negative-side collection portion 5 when battery block 1 is assembled.

As positive electrode plate 12, a metal thin plate having an electric conductivity and an appropriate thickness and strength can be employed. In positive electrode plate 12, the electrode contact portions having a predetermined shape may be formed in plane portion 13 by etching or pressing it, and side surface portion 14 may be folded perpendicularly to plane portion 13 by bending work.

Negative-side collection portion 5 is a connection member that is disposed on the opening on the other side of case 3 and electrically interconnects the negative electrodes of aligned cells 2. FIG. 2 (e) shows negative-side collection portion 5. As shown here, negative-side collection portion 5 includes negative-side insulating plate 16, negative electrode collector 17, and negative electrode plate 18. Each of negative-side insulating plate 16 and negative electrode collector 17 includes cut-away portions corresponding to grooves 8 and 9 described for case 3. Negative electrode plate 18 includes screw holes for fastening members 25 and 26 at the places corresponding to grooves 8 and 9.

Negative-side insulating plate 16 is a plate material that is disposed between case 3, and negative electrode collector 17 and negative electrode plate 18 and electrically insulates case 3 from them. Negative-side insulating plate 16 includes 20 openings through which the negative electrodes of cells 2 are exposed. Negative-side insulating plate 16 is formed by processing, in a predetermined shape, a plastic molded article or plastic sheet having a predetermined heat resistance and electrical insulating property.

Negative electrode collector 17 is a thin plate including 20 electrode contact portions. The electrode contact portions are arranged in a positional relation in which each electrode contact portion comes into contact with the negative electrode of each cell 2. In negative electrode collector 17, the electrode contact portions having a predetermined shape may be formed by etching or pressing a metal thin plate having electric conductivity.

Negative electrode plate 18 is an electrode plate that is electrically connected to negative electrode collector 17 and is used for forming one negative-side output terminal by interconnecting 20 electrode contact portions. Negative electrode plate 18 includes plane portion 19, and tip 20 folded from an end in the L direction of plane portion 19 toward the downside on the page of FIG. 2 along the H direction. The folding from plane portion 19 to tip 20 is performed at the end in the L direction and on the holder 6 side, namely on the right side on the page of FIG. 2. In other words, the folding of negative electrode plate 18 and the folding of positive electrode plate 12 are performed at the opposite ends along the L direction of battery block 1.

The amount of folding from plane portion 19 to tip 20 is set so that, when battery block 1 is assembled, the position of tip 20 along the H direction is the same as the position of tip 15 of side surface portion 14 of positive electrode plate 12 along the H direction. FIG. 3 (b) shows that the position of tip 20 along the H direction is the same as that of tip 15 along the H direction.

As negative electrode plate 18, a metal thin plate having an electric conductivity and an appropriate thickness and strength can be employed. In negative electrode plate 18, the electrode contact portions having a predetermined shape are formed by etching or pressing the metal thin plate, and tip 20 is folded perpendicularly to plane portion 19 by bending work.

Holders 6 and 7 are members for fastening, using fastening members, positive-side collection portion 4 disposed on one side of case 3 and negative-side collection portion 5 disposed on the other side, thereby integrating case 3, positive-side collection portion 4, and negative-side collection portion 5. Holders 6 and 7 are made of an insulating material. FIG. 2 (b) shows holders 6 and 7. In this configuration, at both ends of case 3 in the L direction, holder 6 is disposed on the right of the page, and holder 7 is disposed on the left.

As shown in FIG. 2 (b), holders 6 and 7 are disposed so as to fit to grooves 8 and 9 in the opposite surfaces of the outer shape of case 3, respectively. Grooves 8 and 9 are fitting portions to which holders 6 and 7 are fitted. Holders 6 and 7 include wall portions 21 and 22 fitted to side surfaces of case 3, and shafts 23 and 24 fitted into grooves 8 and 9 of case 3, respectively. The ends of each of shafts 23 and 24 include a screw portion for each fastening member. Holders 6 and 7 can be formed by processing an insulating plate material in a predetermined shape. Holders 6 and 7 do not need to be formed separately. For example, the side portion covering a side surface of case 3 may be integrated with the upper portion covering the positive electrodes, or the side portion covering the side surface of case 3 may be integrated with the lower portion covering the negative electrodes.

Fastening members 25 and 26 are screws for fixing negative-side collection portion 5 to holders 6 and 7 using screw portions disposed in shafts 23 and 24 of holders 6 and 7, respectively. Similarly, positive-side collection portion 4 is fixed to holders 6 and 7 using other fastening members (not shown).

In the above description, side surface portion 14 is folded from plane portion 13 in positive electrode plate 12, and tip 20 is folded from plane portion 19 in negative electrode plate 18. However, a reverse configuration may be employed. In other words, a side surface portion may be folded from plane portion 19 in negative electrode plate 18, and a tip may be folded from plane portion 13 in positive electrode plate 12.

Thus, in battery block 1, cells 2 are stored in the case having 20 cell storage portions. At this time, the positive electrodes of cells 2 are aligned on one side, and the negative electrodes thereof are aligned on the other side. Positive-side collection portion 4 is disposed on the positive side, negative-side collection portion 5 is disposed on the negative side, and they are integrated via holders 6 and 7 using appropriate fastening members 25 and 26. The cell storage portions are used for arranging cells 2, so that the positional accuracy of cells 2 is improved, and the positioning accuracy between the positive electrodes of cells 2 and positive-side collection portion 4 and the positioning accuracy between the negative electrodes and negative-side collection portion 5 can be increased. The outer shape of battery block 1 is defined by case 3 and holders 6 and 7 fitted to case 3 regardless of the arrangement of cells 2, so that the dimensional accuracy of the outer shape of battery block 1 is improved. Therefore, battery block 1 can be formed by combining and integrating a plurality of cells 2 at a high accuracy and high workability.

In the above description, one battery block 1 is formed by interconnecting 20 cells 2 in parallel. Thus, battery block 1 having an inter-terminal voltage of 3.6 V and a capacity of (2.5 Ah×20)=50 Ah can be obtained. When increase in the amount of capacity is required, a plurality of battery blocks 1 can be interconnected in parallel. Alternatively, a case having an increased number of cell storage portions, and a positive-side collection portion and negative-side collection portion having an increased number of electrode contact portions may be used. Also in these configurations, a plurality of cells 2 can be combined and integrated at a high accuracy and high workability.

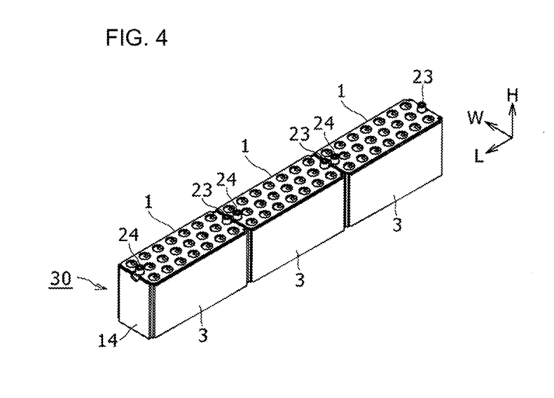

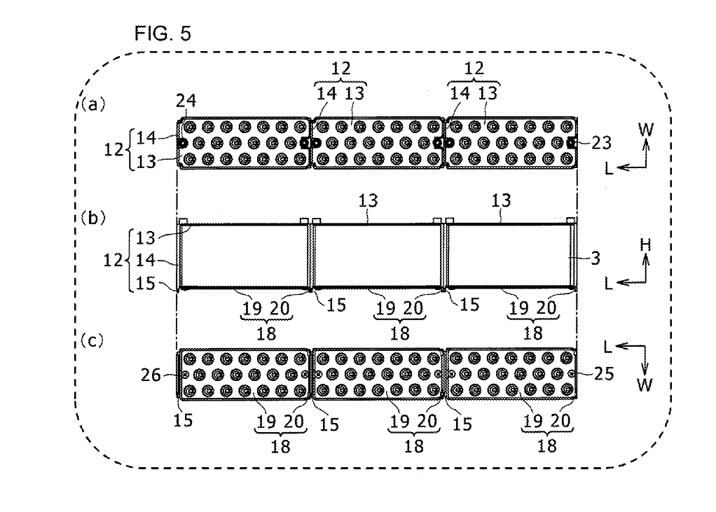

FIG. 4 is a perspective view of battery module 30 that is formed by interconnecting a plurality of battery blocks 1 in series in order to increase the inter-terminal voltage. In this configuration, three battery blocks 1 are interconnected in series. FIG. 5 is a trihedral diagram of battery module 30. FIG. 5 (a) is a top view, FIG. 5 (b) is a front view, and FIG. 5 (c) is a bottom view.

In battery module 30, three battery blocks 1 (described in FIG. 1) are arranged in the L direction while the attitude of each battery block 1 in the L direction, W direction, and H direction shown in FIG. 1 is kept. At this time, as shown in FIG. 5 (a), FIG. 5 (b), and FIG. 5 (c), in a portion where adjacent battery blocks 1 face each other, tip 15 of side surface portion 14 of positive electrode plate 12 of one-side battery block 1 comes to a position that is in contact with tip 20 of negative electrode plate 18 of the-other-side battery block 1. Then, tip 15 of positive electrode plate 12 of one-side battery block 1 is electrically and mechanically connected to tip 20 of negative electrode plate 18 of the-other-side battery block 1 by a connecting/fixing method such as welding. By repeatedly applying this process to adjacent battery blocks 1, the plurality of battery blocks 1 are interconnected in series.

Thus, tip 15 of positive electrode plate 12 and tip 20 of negative electrode plate 18 are disposed on the same side in battery block 1, and the height positions of them are the same, so that wires are easily pulled out. Therefore, even when the plurality of battery blocks 1 are interconnected in series in order to increase the inter-terminal voltage, battery blocks 1 can be combined and integrated at a high accuracy and high workability.

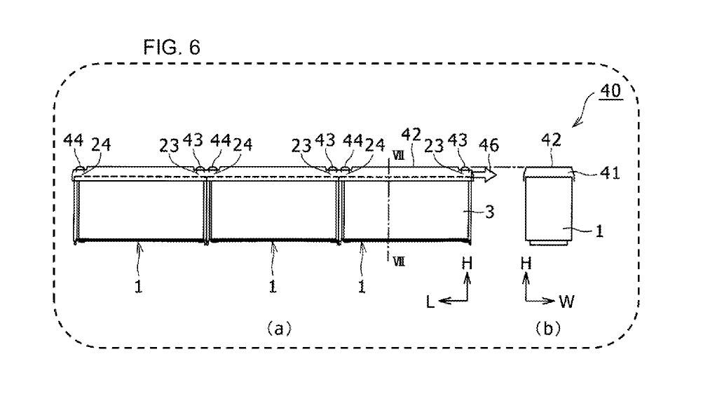

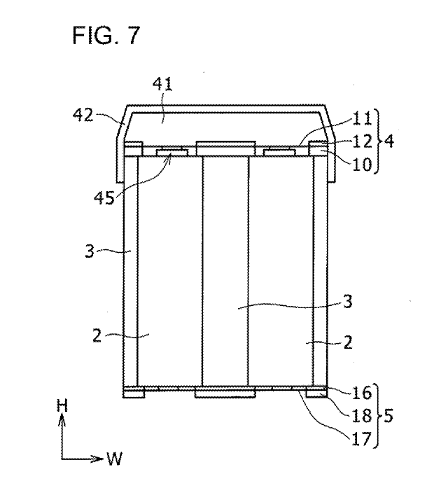

FIG. 6 is a diagram showing the configuration of battery module 40 including duct cover 42 forming duct chamber 41 for releasing exhaust gas coming through safety valves when the safety valves are disposed in cells 2. FIG. 6(a) is a front view, and FIG. 6(b) is a side view. FIG. 7 is a sectional view along line A-A of FIG. 6(a). Safety valve 45 is disposed on the positive side of each cell 2 in FIG. 7, but may be disposed on the negative side of each cell 2. When safety valve 45 is disposed on the negative side, duct cover 42 and duct chamber 41 need to be disposed on the negative side of cells 2.

Safety valve 45 has a mechanism that, when the pressure of the gas generated by an electrochemical reaction performed inside each cell 2 exceeds a predetermined threshold value, releases the generated gas as exhaust gas from the inside of the cell to the outside. Safety valve 45 is disposed in each of 20 cells 2.

Duct cover 42 is a component that covers the positive side of each battery block 1, is air-tightly bonded to the side surfaces of each case 3 of each battery block 1 that extend in the L direction, and forms duct chamber 41 allowing gas to flow on the positive side of each battery block 1. Duct cover 42 is fixed to each battery block 1 by fastening members 43 and 44 using shafts 23 and 24 of holders 6 and 7 of each battery block 1.

Each of cells 2 constituting each battery block 1 includes safety valve 45 on its positive side. By using duct chamber 41, the exhaust gas discharged through safety valve 45 can be passed through duct chamber 41 and released to the outside through a predetermined exhaust port without leaking to another part. FIG. 6 shows flow 46 of the exhaust gas using a hollow arrow. Such duct cover 42 is formed by processing a material having a predetermined heat resistance and strength into a predetermined shape.

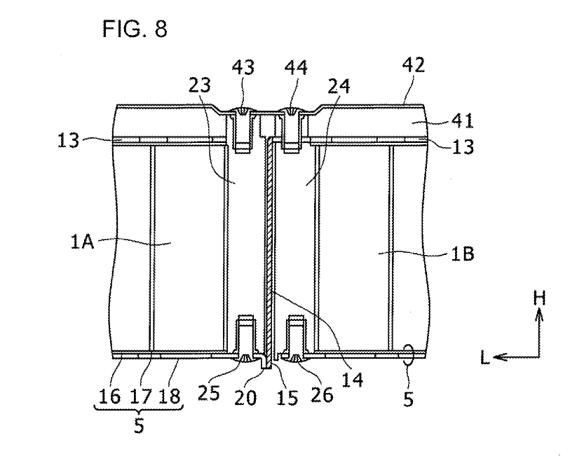

FIG. 8 is a sectional view showing a process of fixing duct cover 42 using shafts 23 and 24 of holders 6 and 7 of each battery block 1. In this configuration, as described in FIG. 2, both of shafts 23 and 24 are made of an insulator.

As shown in FIG. 8, in a portion where adjacent battery blocks 1A and 1B face each other, duct cover 42 is fixed to the positive side of shaft 23 of one-side battery block 1A using fastening member 43, and negative-side collection portion 5 is fixed to the negative side of shaft 23 using fastening member 25. Similarly, duct cover 42 is fixed to the positive side of shaft 24 of the-other-side battery block 1B using fastening member 44, and negative-side collection portion 5 is fixed to the negative side of shaft 24 using fastening member 26.

At this time, side surface portion 14 of positive electrode plate 12 of the-other-side battery block 1B extends from the positive side to the negative side through the clearance between adjacent battery blocks 1A and 1B facing each other, tip 15 comes a position that is in contact with tip 20 of negative electrode plate 18 of one-side battery block 1A. Then, by connecting and fixing tip 15 to tip 20 by welding, adjacent battery blocks 1A and 1B are interconnected in series.

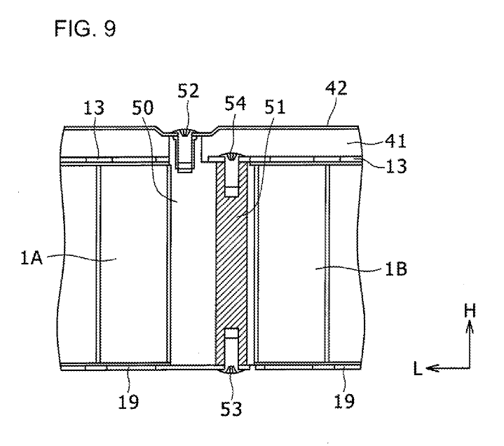

FIG. 9 is a sectional view showing a configuration where two shafts 23 and 24 of FIG. 8 are integrated into one common shaft 50, conductive member 51 extending in the H direction is disposed in common shaft 50, and side surface portion 14 of positive electrode plate 12 is eliminated. Here, common shaft 50 except conductive member 51 is made of an insulator. The positive electrode plate of the-other-side battery block 1B shown on the right side on the page of FIG. 9 is formed only of plane portion 13, and the negative electrode plate of one-side battery block 1A shown on the left side on the page is also formed only of plane portion 19.

Plane portion 13 as the positive electrode plate of the-other-side battery block 1B is electrically connected to the positive side of common shaft 50 using fastening member 54, and plane portion 19 as the negative electrode plate of one-side battery block 1A is electrically connected to the negative side of common shaft 50 using fastening member 53. Thus, adjacent battery blocks 1A and 1B are interconnected in series without using welding. Here, duct cover 42 is fixed to common shaft 50 using fastening member 52.

Thus, in the configuration of FIG. 9, the positive electrode plate and negative electrode plate have a simple structure, and the series connection between adjacent battery blocks 1A and 1B does not require a welding device or the like, and can be easily performed.

### Modified Example of Exemplary Embodiment

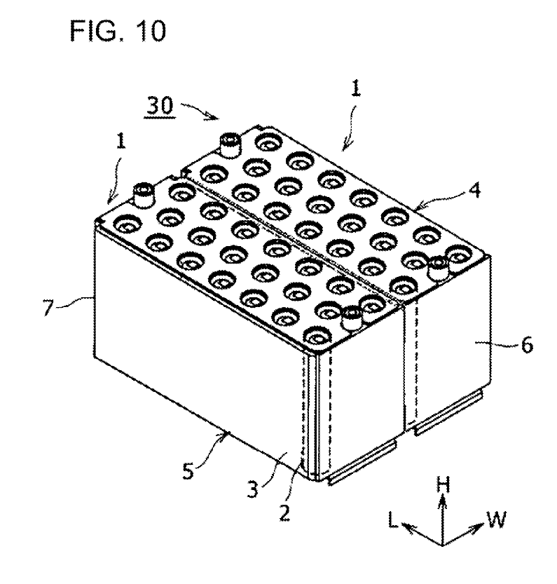

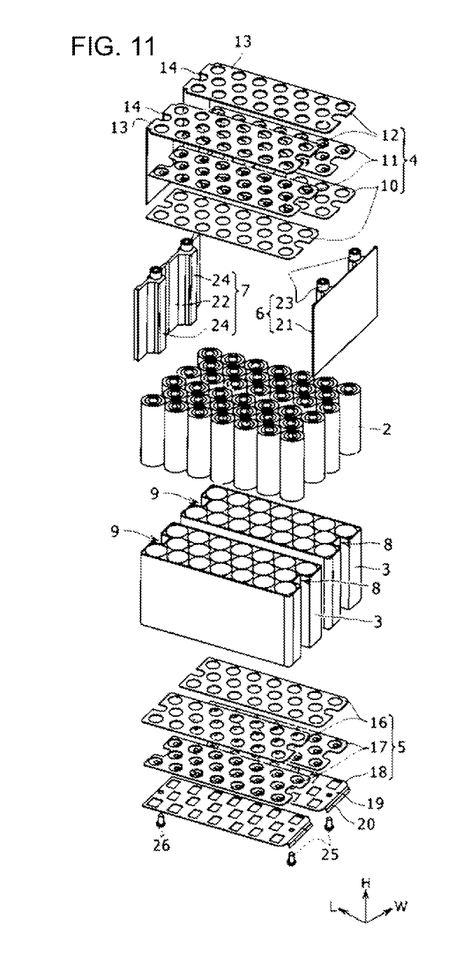

FIG. 10 is a perspective view showing a battery module of a modified example of the present invention. FIG. 11 is a perspective view showing an exploded view of the battery module of the modified example of the present invention. In the modified example of the exemplary embodiment, battery module 30 formed by interconnecting a plurality of battery blocks 1 in the W direction is described. Hereinafter, a part different from the exemplary embodiment is mainly described.

Cells 2, cases 3, positive-side collection portions 4, and negative-side collection portions 5 are arranged in the W direction.

Holders 6 and 7 are members for fastening, using the fastening members, a plurality of positive-side collection portions 4 disposed on one side of a plurality of cases 3 and a plurality of negative-side collection portions 5 disposed on the other side. Holders 6 and 7 are integrated with cases 3, positive-side collection portions 4, and negative-side collection portions 5. Holders 6 and 7 are made of an insulating material. In this configuration, at both ends of case 3 in the W direction, holder 6 is disposed on the right of the page, and holder 7 is disposed on the left.

Holders 6 and 7 are disposed so as to fit to grooves 8 and 9 in the opposite surfaces of the outer shape of each case 3, respectively. Holder 6 includes a plurality of shafts 23 fitted into grooves 8 of the plurality of cases 3. Holder 7 includes a plurality of shafts 24 fitted into grooves 9 of the plurality of cases 3. A screw portion for each fastening member is disposed at the ends of each of the plurality of shafts 23 and 24. The number of shafts 23 and the number of shafts 24 are the same as the number of disposed battery blocks 1.

The plurality of positive-side collection portions 4 are arranged so as to be in contact with each other, the plurality of negative-side collection portions 5 are arranged so as to be in contact with each other, and the plurality of battery blocks 1 are interconnected electrically in parallel.

Thus, holder 6 includes the plurality of shafts 23 and holder 7 includes the plurality of shafts 24. Therefore, the outer shape of the plurality of battery blocks 1 is defined by the plurality of cases 3 and holders 6 and 7 fitted to cases 3 regardless of the arrangement of cells 2, and hence the dimensional accuracy of the outer shape of battery blocks 1 is improved. Therefore, even when battery module 30 formed by interconnecting a plurality of battery blocks 1 in the W direction is employed, battery module 30 can be formed by combining and integrating a plurality of cells 2 at a high accuracy and high workability.

### REFERENCE MARKS IN THE DRAWINGS

1, 1A, 1B battery block
2 cell
3 case
4 positive-side collection portion
5 negative-side collection portion
6, 7 holder
8, 9 groove
10 positive-side insulating plate
11 positive electrode collector
12 positive electrode plate
13 plane portion (of positive electrode plate)
14 side surface portion
15 tip (of positive electrode plate)
16 negative-side insulating plate
17 negative electrode collector
18 negative electrode plate
19 plane portion (of negative electrode plate)
20 tip (of negative electrode plate)
21, 22 wall portion
23, 24, 50 shaft
25, 26, 43, 44, 52, 53, 54 fastening member
30, 40 battery module
41 duct chamber
42 duct cover
45 safety valve
50 common shaft
51 conductive member

1. A battery block comprising:
a plurality of cells;
a case used for arranging the plurality of cells in a predetermined arrangement by aligning positive electrodes of the plurality of cells on a first side and aligning negative electrodes of the plurality of cells on a second side, the case being open on the first side and the second side and holding the plurality of cells along an outer periphery in a longitudinal direction of the plurality of cells;
a positive-side collection portion disposed in an opening on the first side of the case and interconnecting the positive electrodes of the plurality of cells in parallel to collect power;
a negative-side collection portion disposed in an opening on the second side of the case and interconnecting the negative electrodes of the plurality of cells in parallel to collect power;
two holders disposed so as to fit to opposite surfaces of an outer shape of the case, respectively, and made of an insulator; and
a fastening member for fastening the positive-side collection portion and the negative-side collection portion via the two holders.

2. The battery block according to claim 1, wherein
the predetermined arrangement includes a staggered arrangement minimizing a clearance between adjacent cells of the plurality of arranged cells,
the case includes grooves having no cell at both ends in a direction along a row of the plurality of cells arranged in the staggered arrangement, and
the two holders are fitted to the grooves of the case.

3. The battery block according to claim 2, wherein
the grooves extend from one side to the other side of the plurality of cells along the longitudinal direction of the plurality of cells, and are recessed toward a portion having the plurality of arranged cells.

4. A battery module formed by interconnecting in series a plurality of battery blocks each of which includes a plurality of cells interconnected in parallel, wherein
each of the plurality of battery blocks includes:
the plurality of cells;
a case used for arranging the plurality of cells in a predetermined arrangement by aligning positive electrodes of the plurality of cells on a first side and aligning negative electrodes of the plurality of cells on a second side, the case being open on the first side and the second side and holding the plurality of arranged cells along an outer periphery in a longitudinal direction of the plurality of cells;
a positive-side collection portion disposed in an opening on the first side of the case and interconnecting the positive electrodes of the plurality of cells in parallel to collect power;
a negative-side collection portion disposed in an opening on the second side of the case and interconnecting the negative electrodes of the plurality of cells in parallel to collect power;
two holders disposed so as to fit to opposite surfaces of an outer shape of the case, respectively, and made of an insulator; and
a fastening member for fastening the positive-side collection portion and the negative-side collection portion via the two holders.

5. The battery module according to claim 4, wherein
one collection portion of the positive-side collection portion and the negative-side collection portion in a first battery block of the plurality of battery blocks is folded between the first side and the second side of the case, extends toward the other collection portion, and is electrically connected to the other collection portion in a second battery block adjacent to the first battery block.

6. The battery module according to claim 4, wherein
in a portion where the adjacent battery blocks face each other, one of the holders of the first battery block and one of the holders of the second battery block are integrated into one common holder, and
the common holder is electrically connected to the one collection portion of the positive-side collection portion and the negative-side collection portion of the first battery block, and electrically connected to the other collection portion of the second battery block adjacent to the first battery block.

7. The battery module according to claim 4, wherein
each of the plurality of cells is a safety-valve-equipped cell including a safety valve on the positive side or the negative side,
the positive side or the negative side of each of the plurality of cells on which the safety valve is disposed is set as a safety valve side,
the battery module includes a duct cover that is disposed on the safety valve side of the cases of the plurality of battery blocks, covers the positive-side collection portion or the negative-side collection portion disposed on the safety valve side, and forms a duct chamber for releasing exhaust gas discharged through the safety valve, and
the fastening member fastens the duct cover via the two holders.

8. A holder for a battery block comprising two holders, wherein
each of the two holders is fitted to at least one fitting portion disposed on each of opposite surfaces of an outer shape of at least one case which is used for aligning and holding a plurality of cells in a longitudinal direction,
the two holders are disposed between a positive-side collection portion of the plurality of cells that is disposed on a first side of the case and a negative-side collection portion of the plurality of cells that is disposed on a second side of the case, and are made of an insulator, and
the two holders are fastened to the positive-side collection portion on the first side, are fastened to the negative-side collection portion on the second side, and integrate the case, the positive-side collection portion, and the negative-side collection portion to form the battery block.

9. The holder for the battery block according to claim 8, wherein
the plurality of cells are arranged in a staggered arrangement minimizing a clearance between adjacent cells of the plurality of cells, and
the case includes, as the fitting portions, grooves having no cell at both ends of the case in a direction along a row of the plurality of cells arranged in the staggered arrangement.

10. The holder for the battery block according to claim 9, wherein
the grooves extend from one side to the other side of the plurality of cells along the longitudinal direction of the plurality of cells, and are recessed toward a portion having the plurality of arranged cells.
